(19) United States
(12) Patent Application Publication
(10) Pub. No.: US 2021/0152629 A1
(43) Pub. Date: May 20, 2021

(54) SYSTEM AND METHOD FOR TIME-INDEPENDENT PROVISION OF ELECTRONIC DATA AVAILABLE INTERMITTENTLY VIA A DATA NETWORK

(71) Applicant: Re2You GmbH, Berlin (DE)

(72) Inventor: Ghazaleh Koohestanian, Berlin (DE)

(21) Appl. No.: 17/159,071

(22) Filed: Jan. 26, 2021

Related U.S. Application Data
(63) Continuation of application No. PCT/EP2019/069109, filed on Jul. 16, 2019.

(30) Foreign Application Priority Data
Jul. 27, 2018 (DE) 10 2018 118 287.2

(51) Int. Cl. H04L 29/08; G06F 9/455; G06F 21/62; G06F 3/0484

(52) U.S. Cl. CPC H04L 67/10; G06F 9/45558; G06F 21/6218; G06F 2009/45595; G06F 3/04842; H04L 67/12; H04L 67/06

(57) ABSTRACT

A method and a system for time-independent provision of electronic data available intermittently via a data network are provided. The method includes providing a first virtual computer system having a first virtual data server and being connected to a data network via a cloud computing service, providing a first selection user interface configured to allow a first user to select first electronic data available via the data network for download to the first virtual data server, downloading first electronic data available via the data network to the first virtual data server based on a selection input via the first selection user interface, transmitting the first virtual computer system to a first data processing system connected to the cloud computing service only intermittently and providing the first electronic data downloaded to the first virtual data server while the first data processing system is disconnected from the cloud computing service.

### CROSS REFERENCE TO RELATED APPLICATIONS

This application is a continuation application of international patent application PCT/EP2019/069109, filed Jul. 16, 2019, designating the United States and claiming priority to German application 10 2018 118 287.2, filed Jul. 27, 2018, and the entire content of both applications is incorporated herein by reference.

### TECHNICAL FIELD

The present disclosure relates to a system for time-independent provision of electronic data available intermittently via a data network and to a suitable method for the time-independent provision of electronic data available intermittently via a data network that can be used to operate such a system.

### BACKGROUND

Consumers today are accustomed to having access to information held by them or available via the Internet as electronic data, and in particular also to provided entertainment, at any time, whether at home or out and about, and expect to be able to access provided films, music or other multimedia at any time. It is therefore often felt to be a limitation, in particular on trips, that there is occasionally no Internet connection, depending on the chosen means of transport, or the data transmission rate available for the passenger is too low to be able to use high-quality provided multimedia. For example, a passenger on an aircraft occasionally has no such access available during a flight, likewise a passenger on a cruise ship at sea, for example. A passenger on a railway train also usually has, if any, only a low-data-rate connection available when the train is moving. In motor vehicles too this access for passengers is dependent on the availability of an appropriately powerful network in the area currently being driven through, for example, even though the foreseeable increase in proposals to use autonomously driving vehicles that no longer require a driver means that the number of parties interested in provided entertainment during a journey will increase further.

In order to be able to provide passengers with an offering of entertainment nevertheless, for example some operators of means of mass transport therefore provide passengers with entertainment offerings that allow a passenger to access media stored on board. As such, for example many airlines offer passengers a selection of movies to watch on long-haul flights.

U.S. Pat. No. 4,647,980 describes, for example, a television system for air passengers for whom a plurality of recorded programs is transmitted to receiving modules with screens that are inset in the backrest of passenger seats, the passenger in the next row of seats then being able to select which of the transmitted programs, e.g., which movie, is to be displayed on the screen.

However, onboard entertainment systems of this kind firstly have the disadvantage that the entertainment media on offer are preselected by the operator of the means of transport, e.g., the airline, and therefore correspond to the interests of the individual passenger only to a limited extent. Secondly, the operator of the means of transport needs to ensure, if necessary, by paying license fees, that it also has the rights to provide the media, with the effort and costs for this possibly increasing on the basis of the number and currentness of the media provided, for example.

Alternatively providing passengers with the option of connecting a device that they have brought aboard themselves, for example a computer or smartphone, or a data storage medium of their own, to the onboard entertainment system in order to be able to play media that they have brought themselves may be either not permitted or permitted only to a limited extent, e.g., for security reasons, for example in order to prevent intentional or unintentional loading of malware in an aircraft or unauthorized access to the onboard electrical system.

Moreover, consumers increasingly obtain their entertainment media via the Internet from online providers that provide for example a large selection of current films or pieces of music for streaming or download to a computer or other display device of the consumer for personal use, for example after registration as a customer and in return for a fee. Transmitting such media to an onboard entertainment system of an operator of a means of transport in order to display them there can sometimes require the operator to also have to purchase rights from the media provider for this purpose.

### SUMMARY

It is therefore an object of the present disclosure to provide a user, i.e., a passenger of a means of transport, which cannot access arbitrary personally selected electronic data, in particular personally selected entertainment media having a large data volume, which can be obtained via a data network, of the user at any time with a simple way of using an onboard data processing system, for example an onboard entertainment system, to access the electronic data in a manner that is low risk for the operator of the data processing system.

This object is achieved according to the disclosure by a method for time-independent provision of electronic data available intermittently via a data network and a system for the time-independent provision of electronic data available intermittently via a data network as described herein.

According to a first aspect of the disclosure, a method for the time-independent provision of electronic data available intermittently via a data network includes providing a first virtual computer system via a cloud computing service, wherein the first virtual computer system has a first virtual data server and is connected to a data network. The method additionally includes providing a first selection user interface apparatus, connectable to the first virtual computer system, that is configured to allow a first user to select first electronic data available via the data network for download to the first virtual data server. Additionally, the method includes downloading first electronic data available via the data network to the first virtual data server on the basis of a selection that is input via the first selection user interface apparatus. The method also includes transmitting the first virtual computer system to a first data processing system, connected to the cloud computing service only intermittently, that has a first output user interface apparatus, and providing the first electronic data downloaded to the first virtual data server via the first output user interface apparatus while the first data processing system is disconnected from the cloud computing service.

Classifying the cited terms as “first”, for example “first electronic data” or “first user”, serves merely to distinguish them from “second” or “further” units of the same or similar type also mentioned below and implies no kind of prioritization unless explicitly indicated.

A cloud computing service provides an information-technology data processing infrastructure via a data network, in particular the Internet, as a service, for example storage space, processing power and/or specific user software, to which end the cloud computing service is executed on one or more data processing infrastructure apparatuses in the form of computers, data processing systems or other programmable apparatuses with processor and memory that have one or more connections to at least one data network via a network interface via which the cloud computing service can be accessed and via which the cloud computing service allows for example programs executed by it to access the data network.

A virtual computer system is also referred to as a virtual machine and reproduces the computer architecture of a computer available only hypothetically or in hardware and is executable in a manner encapsulated in another, physically existent, computer system or data processing system. If the first virtual computer system is made available to a first user via the cloud computing service, this allows the first user to use the first virtual computer system while it is executed in a manner encapsulated on at least one of the data processing infrastructure apparatuses that provide the cloud computing service, wherein, usually with an abstracting layer between the virtual computer system and the hosting data processing infrastructure apparatus as host computer or host computer system, the physical hardware thereof, in particular in this case also the network interface of the data processing infrastructure apparatus (and via this the connected data network), can be accessed.

A first virtual data server is provided within, i.e., as part of, the first virtual computer system as a virtual component of the computer architecture of the first virtual computer system, which server can be used to store electronic data, for example entertainment media such as film, music and audio files, but also any other form of information representable as electronic data, that are available via the data network connected via the network interface.

The electronic data include video, audio, text or multimedia data, in particular used for entertaining the user, also having a large data volume, that are provided by third-party providers, i.e., not the user and not the operator of the data processing system connected to the cloud computing service only intermittently, via a data network, e.g., movies via free or fee-based media-download and streaming platforms on the Internet.

The electronic data are selected by the first user by using a first selection user interface apparatus configured to allow the first user to select first electronic data available via the data network for download to the first virtual data server. The first selection user interface apparatus is a data processing apparatus having communication capability, for example a smartphone or a computer with a network interface configured to connect, for example by executing a suitable client program, to the cloud computing service via the data network and for example to use a piece of remote access or virtual network computing software to access the first virtual computer system, at least in order to prompt the latter to download selected electronic data from a data source in the data network, for example an online provider of entertainment media or other electronic data, or the data server or data service of said provider that is available via the data network, to the first virtual data server. For the selection the selection user interface apparatus or the executed client program provides for example a graphical user interface that uses a display apparatus, e.g., a screen, of the first selection user interface apparatus to display representations, e.g., titles and/or reduced depictions of representative images of selectable electronic data, e.g., of entertainment media available via the data network, for selection.

“Electronic data available intermittently via a data network” are electronic data, e.g., data represented as digital information, that are provided by a data source via the data network and that can be accessed when a connection to the data network is available, this connection not being available, or not being available in sufficient quality, in certain typical situations, e.g., when an aircraft, ship or other means of transport is moving. Access to the available electronic data may still be restricted independently of this and possible for example only after registration, payment of a fee, agreement to certain conditions of use, compliance with age restrictions, access times or periods and/or only when certain technical prerequisites such as the availability of a minimum required transmission rate for the electronic data are met.

By contrast, electronic data provided independently of time are available for a user at any time, i.e., even in typical situations in which access via the data network is not possible, unless there are restrictions on the access rights.

Accordingly, a first data processing system connected to the cloud computing service intermittently is a data processing system that may be for example a system comprising a computer or multiple networked computers for presenting entertainment media in a means of transport that is not constantly connected to the cloud computing service via the data network.

The transmitting of a virtual computer system includes copying or moving the whole virtual computer system to the data processing system.

An output user interface apparatus is a data processing apparatus having communication capability, for example a computer assigned to the respective user as a passenger of a means of transport as part of the data processing system, which computer is configured to access, for example by executing a suitable client program, the transmitted virtual computer system, either directly or for example via a piece of remote access or virtual network computing software, at least in order to access the electronic data downloaded to the virtual data server. For this the output user interface apparatus provides a display apparatus, e.g., a screen, and a graphical user interface with which access to the electronic data can be controlled, for example the selection and starting of the display of a movie stored on the virtual data server.

There is provision for the first electronic data downloaded to the first virtual data server to be provided via the first output user interface apparatus while the first data processing system is disconnected from the cloud computing service. This does not prevent the connection to the cloud computing service from continuing, but not in such a way that it would be necessary in order to be able to display the electronic data that are to be output.

The method described can be used by a user to select electronic data, including those having a large data volume, such as for example movies, according to his own interests and, even if it is obtained from a media platform in the data network, in particular the Internet, with personal access, to download it to a data server available to the user, said data server being transmitted to the data processing system as well, as a result of said data server being realized as a virtual data server of a virtual computer system, when the virtual computer system is transmitted to the data processing system connected to the data network only intermittently, which data processing system is on board a means of transport, for example. This takes place without the downloaded electronic data leaving the encapsulated virtual computer system. Even for example use, inevitably envisaged by third-party providers, of client software of the third-party provider on the computer system of the user or authentication of the user or tying of the downloaded medium, i.e., the electronic data, to the computer system of the user can be made possible in this manner, since the medium does not leave the virtual computer system belonging to the user even when the virtual computer system, which may also have the required access software or may meet the required authentication prerequisites, is transmitted. The user can then use his electronic data aboard the means of transport, the output interface apparatus allowing him to access his personal virtual computer system to display electronic data or media too.

Therefore, in one exemplary embodiment of the method, providing the first virtual computer system involves providing the first virtual computer system having a first selection client, with which first electronic data available from a first provider of electronic data are selectable via the data network for download to the first virtual data server. The first virtual computer system thus has a client with which selection of data available in the data network is possible. If the user can access the virtual computer system, then the user can use the selection client to select electronic data for download.

The first provider of electronic data may be a third-party provider, described above, having a media platform on the Internet but also a, for example cloud-based, data server storing personal electronic data of the user, in particular including self-generated electronic data, for example photographs or videos.

In one exemplary embodiment, providing the first selection user interface apparatus connectable to the first virtual computer system involves allowing the first user to select first electronic data for download to the first virtual data server by virtue of the first selection user interface apparatus being connected to the first virtual computer system such that the first selection client can be used by the first user via the first selection user interface apparatus. In this manner, the functionality of the first selection client provided on the first virtual computer system via the cloud computing service can be used via the first selection user interface apparatus. This is accomplished, for example, with a piece of remote access or virtual network computing software that is used to access the first virtual computer system, e.g., by using the remote frame buffer protocol or another network protocol that allows access to the graphical user interfaces of other, including remote, computer systems and the transmission of screen content and inputs of the user.

In one exemplary embodiment of the method, providing the first virtual computer system involves providing the first virtual computer system having a first output client, with which the first electronic data downloaded to the first virtual data server are retrievable for output. In this manner the first virtual computer system itself provides a way of accessing the electronic data downloaded to the virtual data server, the first output client possibly having been adapted for access rights of the user or for other stipulations, for example of a third-party provider from which the electronic data were downloaded. The output client and the selection client may be embodied separately or as a common program.

In one exemplary embodiment, providing the first electronic data downloaded to the first virtual data server via the first output user interface apparatus involves the first output user interface apparatus being connected to the first virtual computer system such that the first output client can be used by the first user via the first output user interface apparatus. In this manner, the functionality of the first selection client provided on the first virtual computer system can be used via the first selection user interface apparatus, even if the first virtual computer system was transmitted to the first data processing system connected to the data network only intermittently, even if said first data processing system is no longer connected to the data network. This is also accomplished for example with direct access or a piece of remote access or virtual network computing software with which the connection of the first output user interface apparatus is used to access the first virtual computer system.

In one exemplary embodiment of the method, downloading the first electronic data available via the data network is also effected on the basis of an authorization of the first user to access the selected first electronic data. An authorization of the user to download the electronic data, for example a movie, may be tied to a successful authentication, the acknowledgement of conditions of use or to the payment of a fee, for example, it being sufficient if this authorization extends to the first user, with authorizations that also cover further users likewise being an authorization of the first user.

In one exemplary embodiment, providing the first electronic data downloaded to the first virtual data server via the first output user interface apparatus is also effected on the basis of the authorization of the first user to access the selected first electronic data. There may thus be provision for the providing of the downloaded first electronic data, in order to said data via the first output user interface apparatus of the data processing system, which is an onboard data processing system of a means of transport, for example, to also provide for the presence of the authorization of the user to access the data to be checked.

In particular there is provision in one exemplary embodiment for the providing of the first electronic data downloaded to the first virtual data server via the first output user interface apparatus to be effected independently of the presence of an authorization, assigned to the first data processing system and not to the first user, to access the selected first electronic data. The authorization thus also does not necessarily include an authorization of the first data processing system that, e.g., belongs to a means of transport (or an authorization assigned to the operator of the data processing system).

In one exemplary embodiment, the transmitting includes converting or filtering the downloaded first electronic data on the basis of system parameters of the first data processing system. The electronic data on the first virtual data server are identified during or after the transmission of the data making up the first virtual computer system and are converted on the basis of parameters of the (physically present) first data processing system. As such there may be provision for example for the video resolution of downloaded films or other video sequences to be converted into a format suitable for the first output user interface apparatus of the first data processing system, for example in order to reduce the storage requirement for the first virtual data server and hence for the first virtual computer system. As such it may be unnecessary, for example, to store video sequences available in a high-resolution (HD) format in this resolution if the screen provided for the user or passenger via the output user interface apparatus can only display the video sequence in a lower resolution anyway. Filtering the electronic data can involve filtering out, for example, with, e.g., only the version of videos stored in multiple resolutions at once that can be presented best with the screen of the first output user interface apparatus being retained. Converting or filtering electronic data is intended to include in particular replacing the original data with the conversion result or filter result, but can also involve storing these as additional data without erasing the original data.

In one exemplary embodiment of the method, transmitting includes filtering the downloaded first electronic data on the basis of clearance settings of an operator of the first data processing system. In particular, transmitting of filtered data also includes not transmitting, i.e., filtering out, electronic data, e.g., videos, that are subject to age restrictions or would be objectionable to other passengers, though it also includes filtering out electronic data or media that do not come from certain providers that the operator of the data processing system or for example the means of transport providing the data processing system has approved, for example. This provides the operator with the advantage of being able to approve only content or media from certain providers of certain online platforms offering download of entertainment media with which the operator of the means of transport, e.g., an airline, has signed an agreement or that guarantee certain quality standards or the like.

Additionally or instead, clearance settings can also include for example providing the operator of the data processing system of the means of transport with an opportunity to set whether, how and what information can be sent to the provider of the electronic data if a connection via the data network still or now exists. By way of example, there may be provision for no data relating to the means of transport, e.g., location data of the means of transport, which are available via the position determination system thereof, for example, to be sent to the provider of the media or for this to be permitted only after consent from the user, instead of permitting otherwise envisaged automatic forwarding of the data.

In one exemplary embodiment, providing the first virtual computer system via the cloud computing service involves providing the first virtual computer system for the first user when said user uses the first selection user interface apparatus to log into the cloud computing service. In particular this also includes an exemplary embodiment in which the operator of the data processing system also provides the user with access to or at least with the access data for the cloud computing service and stipulates a specific configuration of the virtual computer system, as a result of which the user can, e.g., use one or more selection clients of specific providers of electronic data to select his electronic data for download according to personal access by the user to the media databases of the providers.

In a further exemplary embodiment of the method, the method additionally includes providing a second virtual computer system via the cloud computing service, wherein the second virtual computer system has a second virtual data server and is connected to the data network, providing a second selection user interface apparatus, connectable to the second virtual computer system, that is configured to allow a second user to select second electronic data available via the data network for download to the second virtual data server, and downloading second electronic data available via the data network to the second virtual data server on the basis of a selection that is input via the second selection user interface apparatus. The second electronic data available via the data network may be wholly or partially identical to the first electronic data, but do not have to be. The second user can make his selection of second electronic data independently of the first user.

The method can also include providing yet further users with further virtual computer systems via the cloud computing service and allowing further electronic data to be downloaded.

As such, there is also the possibility of more than one user having his respective selected electronic data provided for him on a respective associated virtual data server that can be transmitted to a respective data processing system connected to the data network only intermittently, for example for some or all passengers of a means of transport, for example an aircraft.

In one exemplary embodiment, the method additionally includes transmitting the second virtual computer system to a second data processing system, connected to the cloud computing service only intermittently, that has a second output user interface apparatus, and providing the second electronic data downloaded to the second virtual data server via the second output user interface apparatus. There is thus provision for the second virtual computer system to be transmitted to a second data processing system independently of the first data processing system. This affords the advantage that the data processing systems can be provided for each user, e.g., for each or selected passenger(s) of a means of transport, independently of one another. As such, for example, the data processing systems may be locally tied to the respective seat of the passenger and as such for example can be replaced or updated independently of one another or for example can have different quality features for different seat classes or individually for specific passengers.

In a further exemplary embodiment, the method includes transmitting the second virtual computer system to the first data processing system, which has a second output user interface apparatus assigned to the second virtual computer system and providing the second electronic data downloaded to the second virtual data server via the second output user interface apparatus. In this exemplary embodiment, the second virtual computer system is not transmitted to a second data processing system that is separate from the first data processing system. Instead, it is transmitted to the first data processing system, that is to say the one to which the first virtual computer system is also transmitted, which has a second output user interface apparatus for this purpose, as a result of which both users or passengers can use their own output user interface apparatus to access their assigned virtual computer system.

In one exemplary embodiment, the transmitting of the first and second virtual computer systems includes transmitting the first and second virtual data servers to a common data server of the first data processing system. This allows for example the hardware used to be optimized, e.g., by virtue of the virtual computer systems using the same memory as the first data processing system and not necessarily being arranged close to the seats, but rather being arranged at a central or otherwise particularly suitable location, e.g., a particularly cooled location, while the output user interface apparatuses access them via a wired or wireless data connection.

In one exemplary embodiment, transmitting the first virtual data server and the second virtual data server to a common data server of the first data processing system involves removing redundant electronic data at least in part. This identifies in particular electronic data having an identical content and replaces them with a single version. If, for example, multiple users have decided to download the same current movie to the virtual data server of their virtual computer system then this exemplary embodiment involves said movie being replaced with a single copy that the respective users can all access, as a result of which storage space required can be reduced.

In a further exemplary embodiment, providing the second virtual computer system involves providing the second virtual computer system having a second selection client, with which second electronic data available from a second provider of electronic data are selectable via the data network for download to the second virtual data server. In this case the first and second providers of electronic data may also be the same provider, but do not have to be.

In particular, in one exemplary embodiment, there is provision for the providing of the second selection user interface apparatus connectable to the second virtual computer system to involve allowing the second user to select second electronic data for download to the second virtual data server by virtue of the second selection user interface apparatus being connected to the second virtual computer system such that the second selection client can be used by the second user via the second selection user interface apparatus.

In a further exemplary embodiment, providing the second virtual computer system involves providing the second virtual computer system having a second output client, with which the second electronic data downloaded to the second virtual data server are retrievable for output. As such the second virtual computer system also provides an opportunity for outputting the associated electronic data.

In one exemplary embodiment, the providing of the second electronic data downloaded to the second virtual data server via the second output user interface apparatus also involves the second output user interface apparatus being connected to the second virtual computer system such that the second output client can be used by the second user via the second output user interface apparatus. The second user can therefore use his available second output user interface apparatus to use the second output client associated with the second virtual computer system and to display electronic data or media, for example movies, available on the second virtual data server via his output user interface apparatus.

In one exemplary embodiment of the method, the downloading of the second electronic data available via the data network is also effected on the basis of an authorization of the second user to access the selected second electronic data.

In one exemplary embodiment, providing the second electronic data downloaded to the second virtual data server via the second output user interface apparatus, too, is also effected on the basis of the authorization of the second user to access the selected second electronic data.

By way of example, there is in particular provision for the authorization to access the electronic data to be provided by an authorization assigned to the user and not to the data processing system or the operator thereof. That is to say that the providing of the second electronic data downloaded to the second virtual data server via the second output user interface apparatus is effected independently of the presence of an authorization to access the selected second electronic data that is assigned to the respective data processing system and not to the second user.

In a further exemplary embodiment, transmitting includes converting or filtering the downloaded second electronic data on the basis of system parameters of the respective data processing system, i.e., of the first data processing system or of the second data processing system, depending on the embodiment.

In yet another exemplary embodiment, there is provision for the transmitting, i.e., the transmitting to the first data processing system or to the second data processing system, depending on the exemplary embodiment, to include filtering the downloaded second electronic data on the basis of clearance settings of an operator of the respective data processing system.

In a further exemplary embodiment of the method, providing the second virtual computer system via the cloud computing service involves providing the second virtual computer system to the second user when said user uses the second selection user interface apparatus to log into the cloud computing service.

The above explanations concerning exemplary embodiments that apply to the performance of the method for a first and a second virtual computer system apply accordingly, mutatis mutandis, to performance of the method for a plurality of further virtual computer systems, for example accordingly on the basis of the number of passengers or seats on a means of transport to whose data processing apparatus(es) the electronic data are intended to be transmitted.

According to a second aspect of the disclosure, a system for the time-independent provision of electronic data available intermittently via a data network is provided that it is configured to perform a method according to the first aspect of the disclosure in accordance with one or more of the exemplary embodiments of the method. This implements the advantages and special features of the at least partially computer-implemented method according to the disclosure for the time-independent provision of electronic data available intermittently via a data network within the context of a suitable system too.

In one exemplary embodiment, the system for the time-independent provision of electronic data available intermittently via a data network includes a data processing infrastructure apparatus, performing a cloud computing service, that has a network interface a first virtual computer system, provided via the cloud computing service, that has at least one first virtual data server and is connected to a data network via the network interface of the data processing infrastructure apparatus performing the cloud computing service, a first selection user interface apparatus, connectable to the first virtual computer system, that is configured to allow selection of first electronic data available via the data network for download to the first virtual data server; and a first data processing system, connected to the cloud computing service only intermittently, that has a first output user interface apparatus, wherein the data processing infrastructure apparatus is configured to prompt the cloud computing service first to download first electronic data available via the data network to the first virtual data server on the basis of a selection that is input by a first user via the first selection user interface apparatus and then to transmit the first virtual computer system to the first data processing system connected to the cloud computing service only intermittently when said data processing system is connected to the cloud computing service, wherein the first data processing system is configured to provide the first electronic data downloaded to the first virtual data server via the first output user interface apparatus while the data processing system is disconnected from the cloud computing service.

In one exemplary embodiment of the system, the system includes a first data processing system, connected to the cloud computing service only intermittently, that has a first output user interface apparatus, wherein at least the first data processing system is a data processing system on board a means of transport and the first output user interface apparatus is available to a user as a passenger of the means of transport.

In one exemplary embodiment, the system includes a first virtual computer system provided via a cloud computing service and a first selection user interface apparatus connectable to the first virtual computer system. The first selection user interface apparatus is available to the first user without his being a passenger on the means of transport. For example, it is a smartphone or computer that has an Internet connection and with which the first user is also connected to the cloud computing service, for example in the course of booking a ticket for a means of mass transport, when he has indicated in the course of the booking process that he wishes to take aboard electronic data that are supposed to be accessible to him on board via an output user interface apparatus of a data processing system.

A similar situation applies to second and further users of or passengers on the means of transport, i.e., depending on the embodiment second or further virtual computer systems and second or further selection user interface apparatuses are also provided, and the second data processing system may also be a data processing system on board a means of transport, and the second or further output user interface apparatus is available to a user as a passenger on the means of transport.

In an exemplary embodiment the means of transport is an aircraft, a railway, a ship or a motor vehicle.

### BRIEF DESCRIPTION OF THE DRAWINGS

The disclosure will now be described with reference to the drawings wherein:

FIG. 1 shows a schematic depiction of an illustrative form of a method for the time-independent provision of electronic data available intermittently via a data network according to an exemplary embodiment of the disclosure;

FIG. 2 shows a schematic depiction of a first illustrative form of a system for the time-independent provision of electronic data available intermittently via a data network according to an exemplary embodiment of the disclosure;

FIG. 3 shows a schematic depiction of a second illustrative form of a system for the time-independent provision of electronic data available intermittently via a data network according to an exemplary embodiment of the disclosure;

FIG. 4 shows a schematic depiction of a third illustrative form of a system for the time-independent provision of electronic data available intermittently via a data network according to an exemplary embodiment of the disclosure; and

FIG. 5 shows a schematic depiction of a fourth illustrative form of a system for the time-independent provision of electronic data available intermittently via a data network according to an exemplary embodiment of the disclosure.

### DESCRIPTION OF EXEMPLARY EMBODIMENTS

Further advantages of the present disclosure are evident from the detailed description and the figures. The disclosure is outlined in more detail below in conjunction with the description of exemplary embodiments that follows and with reference to the accompanying figures.

Identical or similar elements in the figures are provided with identical reference signs where appropriate. Reference signs with and without an apostrophe denote substantially identical elements, elements identified by reference signs with an apostrophe denoting the elements after the cloud computing service has been transmitted to the first or second data processing system.

It goes without saying that other exemplary embodiments can be used and structural or logical changes can be made without departing from the scope of protection of the present disclosure. It goes without saying that the features of the various exemplary embodiments described above and below can be combined with one another unless specifically indicated otherwise. The description should not be considered in a limiting sense therefore, and the scope of protection of the present disclosure is defined by the appended claims.

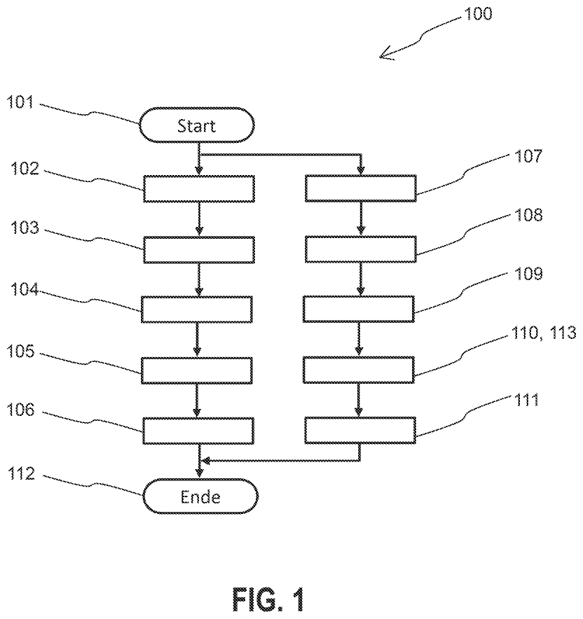

FIG. 1 shows a schematic depiction of an illustrative form of a method 100 according to an exemplary embodiment of the disclosure for the time-independent provision of electronic data available intermittently via a data network. After the start 101 a first virtual computer system is provided 102 via a cloud computing service, the first virtual computer system having a first virtual data server and being connected to a data network.

In the next step a first selection user interface apparatus, connectable to the first virtual computer system, that is configured to allow a first user to select first electronic data available via the data network for download to the first virtual data server is provided 103.

The selecting is followed by first electronic data available via the data network being downloaded 104 to the first virtual data server on the basis of a selection that is input via the first selection user interface apparatus.

The first virtual computer system is then transmitted 105 to a first data processing system, connected to the cloud computing service only intermittently, that has a first output user interface apparatus. Since the transmitting 105 is effected to a data processing system that may also intermittently not be connected to the data network the step of transmitting 105 also encompasses checking whether the first data processing system is currently available via the data network, the transmission not being effected, or being delayed, until the first data processing system is available via the data network, which means that the transmission can be effected.

After the transmitting 105 of the first virtual computer system to the first data processing system has been performed, the first electronic data downloaded to the first virtual data server are provided 106 via the first output user interface apparatus while the first data processing system is disconnected from the cloud computing service. The providing 106 of the first electronic data via the first output user interface apparatus comprises providing the first user with the opportunity to use the output user interface apparatus to select one of the media from the electronic data that are now present on the virtual data server in the first virtual computer system (if the transmitting is not moving but rather copying then this is a copy of the virtual computer system), which to the first data processing system, which is situated in a means of transport, for example, and to display the selected medium via the first output user interface apparatus, which, e.g., also includes a screen.

In the exemplary embodiment of the method shown in FIG. 1, there is moreover provision for a second virtual computer system to be provided 107 via the cloud computing service, the second virtual computer system having a second virtual data server and being connected to the data network.

For the provided second virtual computer system too, there is provision for providing 108 a second selection user interface apparatus, connectable to the second virtual computer system, that is configured to allow a second user to select second electronic data available via the data network for download to the second virtual data server.

When the providing 108 of the second selection user interface apparatus has prompted the second user to make a selection for the purpose of selecting, second electronic data available via the data network are downloaded 109 to the second virtual data server on the basis of a selection that is input via the second selection user interface apparatus.

The second virtual computer system is then transmitted 110 to a second data processing system, connected to the cloud computing service only intermittently, that has a second output user interface apparatus, and the second electronic data downloaded to the second virtual data server are provided 111 via the second output user interface apparatus. The providing 111 can include, e.g., a (also repeated) selection by the second user, now using the second output user interface apparatus, of second electronic data and display thereof, e.g., via a screen of the second output user interface apparatus.

The method ends in the next step 112.

In an alternative exemplary embodiment of the method, the step of transmitting is transmitting 113 the second virtual computer system to the first data processing system, which has a second output user interface apparatus assigned to the second virtual computer system. In this exemplary embodiment, the second virtual computer system is transmitted not to a second data processing system separate from the first data processing system but rather to the same first data processing system to which the first virtual computer system is also transmitted.

The method is shown for two users by way of illustration. In other exemplary embodiments (not shown), the method can also include providing further users with further virtual computer systems via the cloud computing service and allowing further electronic data to be downloaded. An application for just one user is likewise possible.

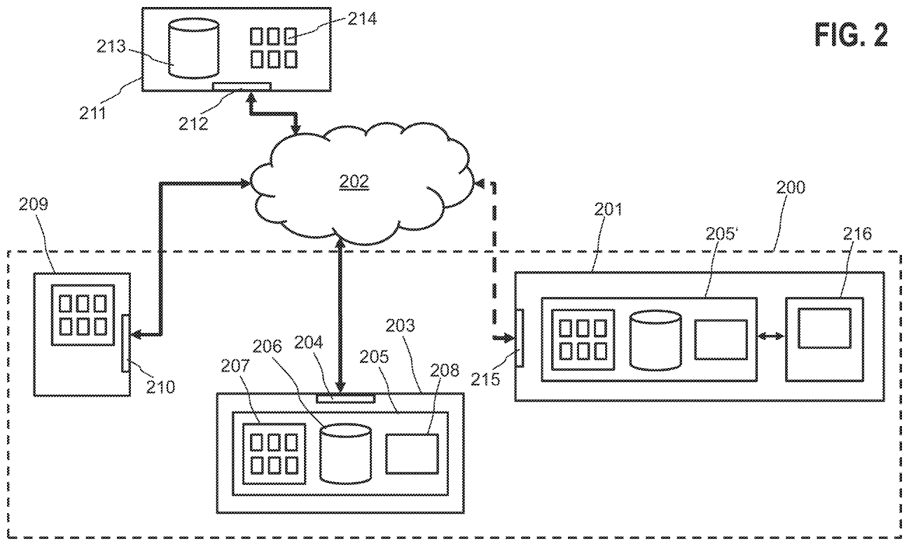

FIG. 2 shows a schematic depiction of a first illustrative form of a system according to an exemplary embodiment of the disclosure for the time-independent provision of electronic data available intermittently via a data network. The system 200 can be used for example to make electronic data, for example individual media or media files, e.g., movies, photographs, audio files or text files, available on a (first) data processing system 201 on board a means of transport, e.g., an aircraft, that is connected to a data network 202, such as the Internet, only intermittently, e.g., only while stopped at an airport, according to the interests of a user. The connection that exists only intermittently is depicted as a broken double-headed arrow in FIG. 2.

The (first) user is thus able, when later aboard the aircraft as a passenger, to have his (first) electronic data, i.e., his previously selected media, available and to display movies, for example.

To this end, the system 200 for the time-independent provision of electronic data available intermittently via a data network 202 includes a data processing infrastructure apparatus 203 that performs a cloud computing service, i.e., includes one or more programmable apparatuses having one or a plurality of processors and memories (not shown) that perform the cloud computing service, which users can access via the data network 202. For this purpose, the data processing infrastructure apparatus 203 performing the cloud computing service has at least one first network interface 204.

The cloud computing service is used to provide a first virtual computer system 205, i.e., a first virtual machine. The first virtual computer system 205 is provided, e.g., when the first user, as a customer of the airline in whose aircraft the user wishes to use his media as a passenger, uses an Internet portal of the airline to log into the cloud computing service for the first time in the course of the booking process for his ticket. This is accomplished for example with access data that he has obtained in the course of the booking process after having indicated that he wishes to use his own media, or media that he himself has downloaded from the Internet, during the flight. When the first user first logs into the cloud computing service, the latter generates the first virtual computer system 205 for the first user, which first virtual computer system has, besides an operating system, at least one first virtual data server 206, initially without media or first electronic data selected by the first user. Furthermore, the first virtual computer system 205 in the embodiment shown has a first selection client 207 and a first output client 208 and is connected to the data network 202 via the first network interface 204 of the data processing infrastructure apparatus 203 performing the cloud computing service.

The first user has a first selection user interface apparatus 209. This can be a smartphone or a computer, likewise having a wireless or wired second network interface 210, for example can be the device that the first user is also using or has used to perform the booking process. The first selection user interface apparatus 209 is connectable to the first virtual computer system 205 available via the cloud computing service, for example by using a piece of remote access or virtual network computing software. As shown in FIG. 2, the connection is likewise made via the data network 202. In other exemplary embodiments, there may be provision for other options for making a connection between the first selection user interface apparatus 209 and the first virtual computer system 205 available via the cloud computing service, for example a wired or wireless direct connection to the data processing infrastructure apparatus 203.

The first selection user interface apparatus 209 is configured to allow first electronic data available via the data network 202 to be selected for download to the first virtual data server 206. To this end, the first selection user interface apparatus 209 in the exemplary embodiment shown, while connected to the first virtual computer system 205 available via the cloud computing service, accesses the first selection client 207 of said first virtual computer system, as a result of which the first user using the first selection interface apparatus 209 can use the functions of the first selection client 207.

Providers of electronic data, in particular online platforms of media providers, are available via the data network 202. The first selection client 207 can be used to select, e.g., first electronic data available from a first provider 211 of electronic data, for example various movie files, via the data network 202 for download to the first virtual data server 206. For this purpose, the first provider 211 of electronic data provides, e.g., a first media database server 213, which is likewise available via a third network interface 212 and on which various electronic data, e.g., various movies, are provided, symbolized in FIG. 1 by associated first selection images 214.

The first user thus uses the first selection client 207, which can be used via the first selection user interface apparatus, to access the first media database server 213 of the first provider 211 of electronic data and selects one or more movie files for download to the first virtual data server 206 in the first virtual computer system 205 available via the cloud computing service. To this end, the first provider 211 may have provided for an authorization check, as a result of which the first user can select movie files of the first provider 211 of electronic data for download only if he personally has authorization to do so, for example linked to the payment of a fee. Limited conditions of use are also usually not a problem, because download to a personal computer (in this case the first virtual computer system 205) of the first user for personal use corresponds to normal, usually permissible, use of the movie file.

The means of transport, in the present example the aircraft, has the first data processing system 201, which is suitable at least for displaying to the first user, as a passenger, his first electronic data, i.e., his personal media or, e.g., movie files downloaded via the data network 202, provided that they have been transmitted to the first data processing system 201 via a fourth network interface 215 of the first data processing system 201. The transmission is effected when there is a connection to the data network 202 for an aircraft in particular at the airport prior to departure. During this time, the transmissions of the virtual computer systems to a data processing system onboard the aircraft are performed for each user, i.e., each passenger, for whom a virtual computer system 205 assigned to him has been generated in the cloud computing service and electronic data have been downloaded to the respective virtual data server of said virtual computer system. In one exemplary embodiment, this happens only if the passenger has also actually already boarded.

The first data processing system 201 is connected to the cloud computing service only intermittently. For example, on a long-haul flight there is then intermittently no longer the option of still making a connection to the cloud computing service via the data network 202.

The first data processing system 201 has a first output user interface apparatus 216. This is in particular a screen, for example a flat screen inset in the backrest of the respective seat in front, possibly including an interface for outputting audio signals, in combination with an interaction interface for the user, for example provided by using a touch-sensitive screen and/or control with keys, a trackball, a joystick, a keyboard or another input means.

On the basis of the selection that is input by the first user via the first selection user interface apparatus 209, which selection may already have been made in advance, for example in connection with booking the ticket for the user or passenger, the data processing infrastructure apparatus 203 prompts the cloud computing service to first download first electronic data available via the data network 202 to the first virtual data server 206 and then, in particular at a time at which the means of transport, i.e., the aircraft, is connected to the cloud computing service, e.g., via the data network 202, to transmit the first virtual computer system 205 to the first data processing system 201 connected to the cloud computing service only intermittently, the first data processing system 201 being configured to provide the first electronic data downloaded to the first virtual data server 206, which data were transmitted as well when the first virtual computer system 205 was transmitted to the first data processing system 201, as a result of which the first virtual computer system 205′ is now available there, e.g., as a copy, via the first output user interface apparatus 216 while the first data processing system 201 is disconnected from the cloud computing service (again).

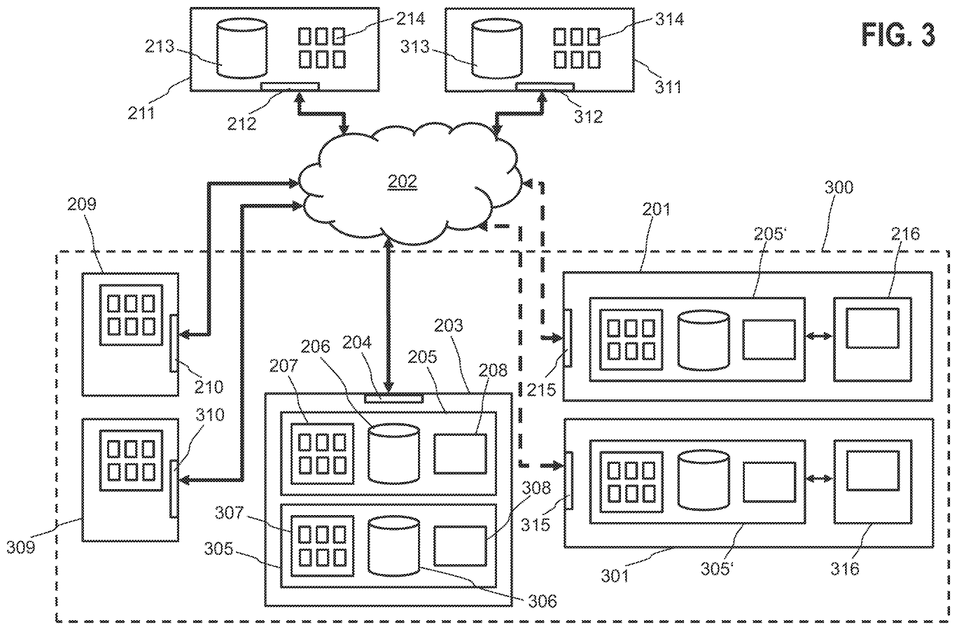

FIG. 3 shows a schematic depiction of a second illustrative form of a system 300 according to an exemplary embodiment of the disclosure for the time-independent provision of electronic data available intermittently via a data network. Substantial parts of the second illustrative form of the system correspond to those of the system 200 shown in FIG. 2, identical reference signs denoting substantially identical elements and being explained only if expedient in connection with the further elements introduced in FIG. 3. Otherwise, reference is made, for elements having known reference signs, to the explanation thereof in respect of FIG. 2.

In the exemplary embodiment shown in FIG. 3, a first variant of the system depicted in FIG. 2 is shown in which two users can each use the system for electronic data that they have selected themselves. An extension to more than two users is accordingly also possible.

In addition to the first virtual computer system 205, a second virtual computer system 305 is additionally provided via the cloud computing service performed by the data processing infrastructure apparatus 203. When a second user first logs into the cloud computing service, the latter generates the second virtual computer system 305 for the second user, which second virtual computer system has at least one second virtual data server 306 besides an operating system. Furthermore, the second virtual computer system 305 in the exemplary embodiment shown has a second selection client 307 and a second output client 308 and is likewise connected to the data network 202 via the first network interface 204 of the data processing infrastructure apparatus 203 performing the cloud computing service.

The second user has an associated second selection user interface apparatus 309. This may likewise be a smartphone or a computer, likewise with a wireless or wired further second network interface 310. The second selection user interface apparatus 309 is connectable to the second virtual computer system 305 available via the cloud computing service, for example likewise by using a piece of remote access or virtual network computing software.

The second selection user interface apparatus 309 is configured to allow selection of second electronic data available via the data network 202 for download to the second virtual data server 306. To this end, the second selection user interface apparatus 309 in the exemplary embodiment shown, while connected to the second virtual computer system 305 available via the cloud computing service, accesses the second selection client 307 of said second virtual computer system, as a result of which the second user using the second selection interface apparatus 309 can use the functions of the second selection client 307.

Providers of electronic data, in particular online platforms of different media providers, are available via the data network 202. The second selection client 307 can be used to select, e.g., second electronic data, for example various movie files, from a second provider 311 of electronic data, but possibly also from the first provider 211 of electronic data, via the data network 202 for download to the second virtual data server 306. The second provider 311 may also be identical to the first provider 211 or provide at least partially identical electronic data, for example the same movies. For this purpose, the second provider 311 of electronic data provides, e.g., a second media database server 313, which is likewise available via a further third network interface 312 and on which various electronic data, in particular, e.g., various movies, are provided, symbolized in FIG. 3 by associated second selection images 314.

The second user thus uses the second selection client 307, which can be used via the second selection user interface apparatus 309, to access the second media database server 313 of the second provider 311 of electronic data and/or the first media database server 213 of the first provider 211 of electronic data and selects, e.g., one or more movie files for download to the second virtual data server 306 in the second virtual computer system 305 available via the cloud computing service. To this end, the second provider may also have provided for an authorization check, as a result of which the second user can select movie files of the second provider 311 of electronic data for download only if he personally has authorization to do so. A similar situation applies to the second user accessing electronic data of the first provider.

The means of transport, in the present example too the aircraft, has, besides the first data processing system 201, a second data processing system 301, which is suitable at least for displaying to the second user, as a passenger, his personally selected second electronic data, provided that they have been transmitted to the second data processing system 301 via a further fourth network interface 315 of the second data processing system 301. The transmission is effected when there is a connection to the data network 202. The second data processing system 301 is likewise connected to the cloud computing service only intermittently.

The second data processing system 301 has a second output user interface apparatus 316, the design of which corresponds to that of the first output user interface apparatus 216, for example. In another exemplary embodiment, the output user interface apparatuses differ in terms of their properties or their quality, for example depending on whether the output user interface apparatus is intended for a passenger in a first or a second booking class.

On the basis of the selection that is input by the second user via the second selection user interface apparatus 309 the data processing infrastructure apparatus 203 also prompts the cloud computing service to first download second electronic data also available via the data network 202 to the second virtual data server 306 and then to transmit the second virtual computer system 305 to the second data processing system 301 connected to the cloud computing service only intermittently, the second data processing system 301 being configured to provide the second electronic data downloaded to the second virtual data server 306, which data were transmitted as well when the second virtual computer system 305 was transmitted to the second data processing system 301, as a result of which the second virtual computer system 305′ is now available there e.g. as a copy, via the second output user interface apparatus 316 while the second data processing system 301, like the first data processing system, is disconnected from the cloud computing service (again).

In this exemplary embodiment, the users therefore have separate data processing systems available on board the means of transport. This increases data integrity, but also failsafety, since the failure of a single data processing system does not influence or barely influences the availability of the other data processing systems. Moreover, each component of the data processing system and of the selection user interface apparatus can be adjusted for the individual requirements of the users. Such a system, in which individual adjustments for each individual user are possible, is suitable for example for a small number of users or passengers, typically in smaller aircraft and in particular in private aircraft.

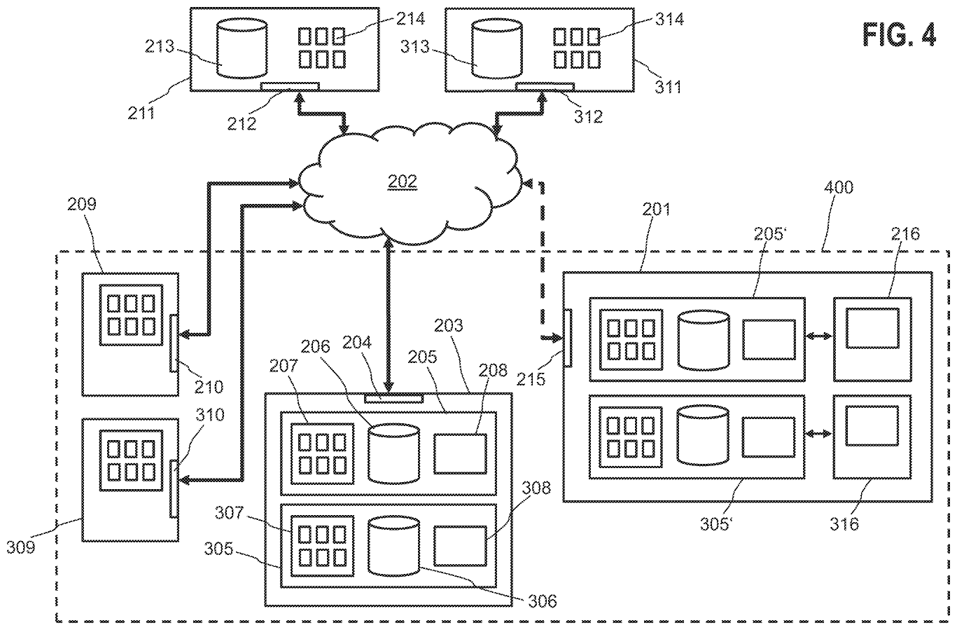

FIG. 4 shows a schematic depiction of a third illustrative form of a system 400 according to an exemplary embodiment of the disclosure for the time-independent provision of electronic data available intermittently via a data network. Substantial parts of the third illustrative form of the system correspond to those of the system 300 shown in FIG. 3 or the system 200 shown in FIG. 2, identical reference signs denoting substantially identical elements and being explained only if expedient in connection with FIG. 4. Otherwise, reference is made for elements having known reference signs, to the explanation thereof in respect of FIG. 3 or FIG. 2.

In the exemplary embodiment shown in FIG. 4, a second variant of the system depicted in FIG. 2 is shown in which two users can each use the system for electronic data that they have selected themselves. An extension to more than two users is accordingly possible in this case too.

In contrast to the exemplary embodiment shown in FIG. 3, the means of transport does not include multiple data processing systems assigned to the different users, but rather the first data processing system 201 is configured for multiple virtual computer systems of multiple users. There is provision for the second virtual computer system 305 to be transmitted to the first data processing system 201, which has, besides the first output user interface apparatus 216, the second output user interface apparatus 316, which is assigned to the transmitted second virtual computer system 305′.

The second output user interface apparatus 316 in this case is thus part not of a second data processing system but rather of the first, i.e., in the present case the only, data processing system. The second electronic data downloaded to the second virtual data server 306 and transmitted with the second virtual computer system 305 as well are provided via the second output user interface apparatus 316. In this exemplary embodiment, the memory and data processing infrastructure for the first data processing system 201 can be for example efficiently matched to an average workload. Moreover, central maintenance or updating of shared data processing infrastructure is possible. The first virtual computer system 201 and the second virtual computer system 301 remain separate from one another.

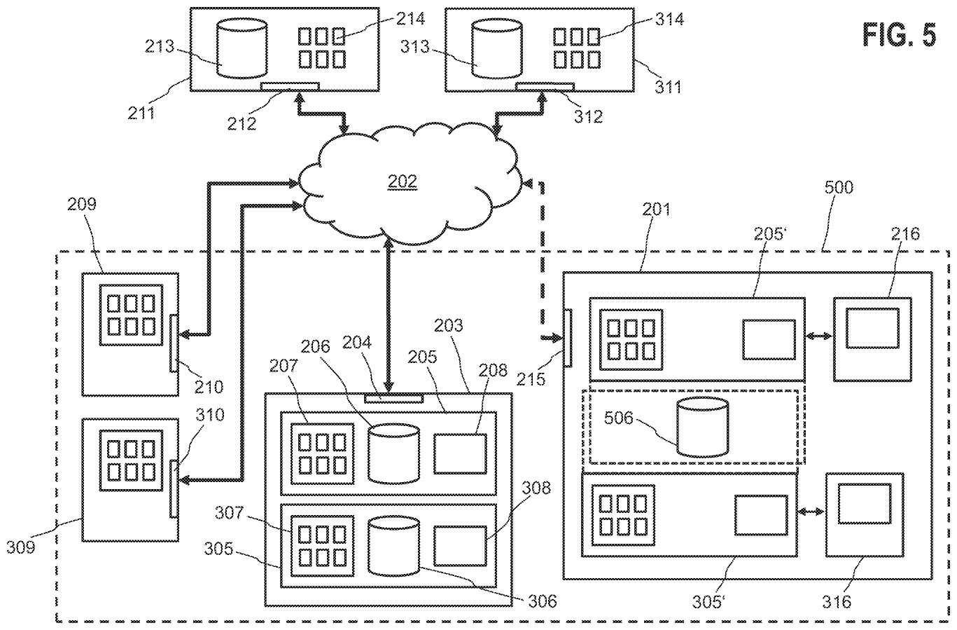

FIG. 5 shows a schematic depiction of a fourth illustrative form of a system 500 according to an exemplary embodiment of the disclosure for the time-independent provision of electronic data available intermittently via a data network. Substantial parts of the fourth illustrative form of the system correspond to those of the system 400 shown in FIG. 4 or the systems shown in FIG. 2 and FIG. 3, identical reference signs denoting substantially identical elements and being explained only if expedient in connection with FIG. 5. Otherwise, reference is made, for elements having known reference signs, to the explanation thereof in respect of the other figures.

In the exemplary embodiment shown in FIG. 5, a third variant of the system depicted in FIG. 2 is shown in which two users can each use the system for electronic data that they have selected themselves. An extension to more than two users is accordingly possible in this case too.

As in the exemplary embodiment shown in FIG. 4, the means of transport does not include multiple data processing systems assigned to the different users, but rather the first data processing system 201 is configured for multiple virtual computer systems of multiple users, the second virtual computer system 305 being transmitted to the first data processing system 201. The second electronic data downloaded to the second virtual data server 306 are provided via the second output user interface apparatus 316. In contrast to the exemplary embodiment shown in FIG. 5, there is provision for a common data server 506 to replace the first virtual data server 206 and the second virtual data server 306 when or after the first virtual computer system 205 and the second virtual computer system 305 are transmitted to the first data processing system 201, with both the first virtual computer system 205′ that is then transmitted and the second virtual computer system 305′ that is then transmitted accessing the common data server 506 as though it is the respective first or second virtual data server. In other words, transmitting the first and second virtual computer systems 205, 305 includes, in this regard, transmitting the first and second virtual data servers 206, 306 to a common data server 506 of the first data processing system 201. This makes it possible to optimize the hardware used for the data server and allows for example redundant electronic data to be removed at least in part. This allows in particular electronic data having an identical content to be identified and replaced with a single version, for example by different users for movies that they have each selected but that are identical, which means that the total required memory space can be reduced.

The figures are not necessarily accurate in every detail and to scale and may be presented in enlarged or reduced form for the purpose of better clarity. For this reason, functional details disclosed here should be understood not to be limiting but merely to be an illustrative basis that gives guidance to a person skilled in this technical field for using the present disclosure in various ways.

Unless indicated otherwise, terms such as “first” and “second”, “further” or the like (for example, first and second virtual computer systems, first and second users, first and second data processing systems, etc.) were used merely to distinguish between the respective elements. Therefore, the use of the terms does not imply a qualitative or any other prioritization of one or the other element.

It goes without saying that method steps, although described in a certain ordered sequence, could sometimes be performed in a different sequence than the one described here. It also goes without saying that certain steps could be performed simultaneously, that other steps could be added or that certain steps described here could be omitted. In other words, the present descriptions are provided for the purpose of illustrating exemplary embodiments and should not be interpreted as being a limitation of the subject matter disclosed.

The expression “and/or” used here, when used in a series of two or more elements, means that any of the elements listed can be used alone, or any combination of two or more of the elements listed can be used. For example, if a composition is described as containing the components A, B and/or C, the composition can contain A alone; B alone; C alone; A and B in combination; A and C in combination; B and C in combination; or A, B, and C in combination.

Although the disclosure has been illustrated and described more thoroughly in detail by the exemplary embodiments, the disclosure is not limited by the examples disclosed and other variations can be derived therefrom by a person skilled in the art without departing from the scope of protection of the disclosure. The disclosure is therefore intended to be restricted not to exemplary embodiments but merely by the appended claims.

### LIST OF REFERENCE NUMERALS

100 method for the time-independent provision of electronic data available intermittently via a data network
101 start
102 provide a first virtual computer system
103 provide a first selection user interface apparatus
104 download first electronic data available via the data network to the first virtual data server
105 transmit the first virtual computer system to first data processing system
106 provide via the first output user interface apparatus
107 provide a second virtual computer system
108 provide a second selection user interface apparatus
109 download to the second virtual data server
110 transmit the second virtual computer system to second data processing system
111 provide via second output user interface apparatus
112 end
113 transmit the second virtual computer system to first data processing system
200 system for the time-independent provision of electronic data available intermittently via a data network
201 first data processing system
202 data network
203 data processing infrastructure apparatus
204 first network interface
205, 205′ first virtual computer system
206 first virtual data server
207 first selection client
208 first output client
209 first selection user interface apparatus
210 second network interface
211 first provider of electronic data
212 third network interface
213 first media database server
214 first selection images
215 fourth network interface
216 first output user interface apparatus
300 system for the time-independent provision of electronic data available intermittently via a data network
301 second data processing system
305, 305′ second virtual computer system
306 second virtual data server
307 second selection client
308 second output client
309 second selection user interface apparatus
310 further second network interface
311 second provider of electronic data
312 further third network interface
313 second media database server
314 second selection images
315 further fourth network interface
316 second output user interface apparatus
400 system for the time-independent provision of electronic data available intermittently via a data network
500 system for the time-independent provision of electronic data available intermittently via a data network
506 common data server

What is claimed is:

1. A method for time-independent provision of electronic data available intermittently via a data network, the method comprising:
providing a first virtual computer system via a cloud computing service, wherein the first virtual computer system has a first virtual data server and is connected to the data network;
providing a first selection user interface connectable to the first virtual computer system, the first virtual computer system being configured to allow a first user to select first electronic data available via the data network for download to the first virtual data server;
downloading first electronic data available via the data network to the first virtual data server based on a selection input via the first selection user interface;
transmitting the first virtual computer system to a first data processing system, connected to the cloud computing service only intermittently, the first data processing system having a first output user interface; and
providing the first electronic data downloaded to the first virtual data server via the first output user interface while the first data processing system is disconnected from the cloud computing service.

2. The method as claimed in claim 1, wherein providing the first virtual computer system includes providing the first virtual computer system having a first selection client, with which the first electronic data available from a first provider of electronic data are selectable via the data network for download to the first virtual data server.

3. The method as claimed in claim 2, wherein providing the first selection user interface connectable to the first virtual computer system includes allowing the first user to select the first electronic data for download to the first virtual data server by virtue of the first selection user interface being connected to the first virtual computer system such that the first selection client can be used by the first user via the first selection user interface.

4. The method as claimed in claim 1, wherein providing the first virtual computer system includes providing the first virtual computer system having a first output client, with which the first electronic data downloaded to the first virtual data server are retrievable for output.

5. The method as claimed in claim 4, wherein providing the first electronic data downloaded to the first virtual data server via the first output user interface includes the first output user interface being connected to the first virtual computer system such that the first output client can be used by the first user via the first output user interface.

6. The method as claimed in claim 1, wherein downloading the first electronic data available via the data network is effected based on an authorization of the first user to access the selected first electronic data.

7. The method as claimed in claim 1, wherein transmitting comprises filtering the downloaded first electronic data based on clearance settings of an operator of the first data processing system.

8. The method as claimed in claim 1, wherein providing the first virtual computer system via the cloud computing service includes providing the first virtual computer system for the first user when the first user uses the first selection user interface to log into the cloud computing service.

9. The method as claimed in claim 1, further comprising:
providing a second virtual computer system via the cloud computing service, wherein the second virtual computer system has a second virtual data server and is connected to the data network;
providing a second selection user interface, connectable to the second virtual computer system configured to allow a second user to select second electronic data available via the data network for download to the second virtual data server; and
downloading the second electronic data available via the data network to the second virtual data server based on a selection which is input via the second selection user interface.

10. The method as claimed in claim 9, further comprising:
transmitting the second virtual computer system to a second data processing system, connected to the cloud computing service only intermittently, the second data processing system having a second output user interface; and
providing the second electronic data downloaded to the second virtual data server via the second output user interface.

11. The method as claimed in claim 9, further comprising:
transmitting the second virtual computer system to the first data processing system, which has a second output user interface assigned to the second virtual computer system; and
providing the second electronic data downloaded to the second virtual data server via the second output user interface.

12. The method as claimed in claim 11, wherein transmitting the first and second virtual computer systems comprises transmitting the first and second virtual data servers to a common data server of the first data processing system.

13. The method as claimed in claim 12, wherein transmitting the first virtual data server and the second virtual data server to the common data server of the first data processing system includes removing redundant electronic data at least in part.

14. The method as claimed in claim 9, wherein providing the second virtual computer system includes providing the second virtual computer system having a second selection client, with which the second electronic data available from a second provider of electronic data are selectable via the data network for download to the second virtual data server.

15. The method as claimed in claim 14, wherein providing the second selection user interface connectable to the second virtual computer system includes allowing the second user to select the second electronic data for download to the second virtual data server by virtue of the second selection user interface being connected to the second virtual computer system such that the second selection client can be used by the second user via the second selection user interface.

16. The method as claimed in claim 10, wherein providing the second virtual computer system includes providing the second virtual computer system having a second output client, with which the second electronic data downloaded to the second virtual data server are retrievable for output.

17. The method as claimed in claim 16, wherein providing the second electronic data downloaded to the second virtual data server via the second output user interface includes the second output user interface being connected to the second virtual computer system such that the second output client can be used by the second user via the second output user interface.

18. The method as claimed in claim 9, wherein downloading the second electronic data available via the data network is effected based on an authorization of the second user to access the selected second electronic data.

19. The method as claimed in claim 9, wherein providing the second virtual computer system via the cloud computing service includes providing the second virtual computer system to the second user when the second user uses the second selection user interface to log into the cloud computing service.

20. The method as claimed in claim 1, comprising performing the method for a plurality of further virtual computer systems.

21. A system for time-independent provision of electronic data available intermittently via the data network, the system being configured to perform the method as claimed in claim 1.

22. The system as claimed in claim 21, the system comprising:
the first data processing system, connectable to the cloud computing service only intermittently, the first data processing system having the first output user interface, wherein at least the first data processing system is a data processing system on board a means of transport and the first output user interface is available to a user as a passenger of the means of transport.

23. The system as claimed in claim 22, further comprising:
the first virtual computer system provided via the cloud computing service; and
a first selection user interface connectable to the first virtual computer system.

24. The system as claimed in claim 22, wherein the means of transport is an aircraft, a railway, a ship, or a motor vehicle.
